(19) United States
(12) Patent Application Publication
(10) Pub. No.: US 2012/0227032 A1
(43) Pub. Date: Sep. 6, 2012

(54) METHOD, APPARATUS, AND SYSTEM FOR INVOKING WIDGET

(76) Inventors: Jie ZHANG, Beijing (CN); Haifang FU, Beijing (CN)

(21) Appl. No.: 13/468,406

(22) Filed: May 10, 2012

Related U.S. Application Data
(63) Continuation of application No. PCT/CN2010/078921, filed on Nov. 19, 2010.

(30) Foreign Application Priority Data
Nov. 20, 2009 (CN) 20091019817.1

(51) Int. Cl. G06F 9/44

(52) U.S. Cl. 717/121; 717/120

(57) ABSTRACT

A method includes: parsing a widget package that is to be run in a terminal to obtain component information in the widget package; obtaining registration information of a component in the widget package according to the component information; when the obtaining of the registration information fails, downloading a component according to component download request information sent by the terminal and updating the registration information; and invoking the downloaded component according to the updated registration information, so that a widget logic component may be updated separately, and a function of a widget terminal is implemented flexibly and easily.

### CROSS-REFERENCE TO RELATED APPLICATIONS

This application is a continuation of International Application No. PCT/CN2010/078921, filed on Nov. 19, 2010, which claims priority to Chinese Patent Application No. 200910109817.1, filed on Nov. 20, 2009, both of which are hereby incorporated by reference in their entireties.

### FIELD OF THE INVENTION

The present invention relates to the field of communications, and in particular, to a method, an apparatus, and a system for invoking a widget.

### BACKGROUND OF THE INVENTION

A widget is a mini downloadable application program, which is realized based on a computer language, such as HTML (Hypertext Markup Language, hypertext markup language), JavaScript or CSS (Cascading Style Sheets, cascading style sheets). The widget is a small application that is realized by a markup language (such as HTML, XML or CSS) and/or a scripting language (such as JavaScript). According to different running environments, widgets may be classified into: a desktop widget, a web widget, and a mobile widget. The desktop widget may be understood as a widget that needs to be downloaded separately and runs on the desktop of a PC; the web widget may be understood as a widget that is a part of a web page and can implement an independent function; and a mobile widget may be understood as a widget that runs in an embedded device or a mobile device (such as a mobile phone, a digital photo frame, or a digital television).

Invoking and management of a widget are generally implemented by a widget terminal. The widget runs on a terminal device (such as a PC, a mobile phone, a digital photo frame, or a digital television), and the terminal device can parse, present and manage the widget and provide the widget with a running environment, an API (Application Programming Interface, application programming interface) adaption function, and other functions.

As shown in FIG. 1, a widget terminal generally includes two parts: a widget manager and a widget parsing unit.

The widget manager is responsible for user and widget management, for example, managing user configuration information, recording a using log, downloading, updating, and deleting a widget package, and other enhanced functions (such as traffic statistics, security authentication, and advertisement support); and the widget parsing unit is configured to parse and run a widget file, and includes a widget unpacking unit, a markup language (HTML or XML) engine, a scripting language (JavaScript) engine, and a CSS engine.

Service logic is expressed by using a script code (such as JavaScript), and a manner for loading a script code is more flexible: The script code may be placed inside a widget and downloaded together with the widget to a terminal, and may also be placed on a server, and when a widget is running, a widget manager and a widget parsing unit dynamically request loading of a script file or dynamically request a result of execution.

A widget terminal includes a widget manager and a widget parsing unit, expression capability of a scripting language itself in the widget terminal is limited, and is weaker when compared with that of high level languages (Java, C, and C++), and implementation of a function of the widget terminal is inflexible and is not suitable for describing a complex service.

### SUMMARY OF THE INVENTION

Embodiments of the present invention provide a method, an apparatus, and a system for invoking a widget to improve flexibility of implementing a function of a widget terminal.

An embodiment of the present invention provides a method for invoking a widget, including the following steps:

parsing a widget package that is to be run in a terminal to obtain component information in the widget package;

obtaining registration information of a component in the widget package according to the component information;

when the obtaining of the registration information fails, downloading a component according to component download request information sent by the terminal, and updating the registration information; and

invoking the downloaded component according to the updated registration information.

An embodiment of the present invention further provides a terminal for invoking a widget, including:

a parsing unit, configured to parse a widget package that is to be run in a terminal to obtain component information in the widget package;

a component registering unit, configured to obtain registration information of a component in the widget package according to the component information; and

a component managing unit, configured to download, when the obtaining of the registration information fails, a component according to component download request information and update the registration information; and invoke the downloaded component according to the updated registration information.

An embodiment of the present invention further provides a system for invoking a widget, including a widget terminal and a widget server, where:

the widget terminal is configured to parse a widget package that is to be run in the widget terminal to obtain component information in the widget package; obtain registration information of a component in the widget package according to the component information; and when the obtaining of the registration information fails, send component download request information; and

the widget server is configured to deliver a component according to the component download request information of the widget terminal;

where, after downloading the component from the widget server and updating the registration information, the widget terminal invokes the downloaded component according to the updated registration information.

An embodiment of the present invention further provides a method for invoking a widget, including the following steps:

receiving component download request information reported by a widget terminal;

delivering a request for device information to the widget terminal according to an internal policy; and

after receiving a device information list that is reported by the widget terminal after the widget terminal collects device information according to the request for device information, delivering a component for downloading to the widget terminal.

An embodiment of the present invention further provides an apparatus for invoking a widget, including: a policy managing module, configured to deliver, after receiving component download request information reported by a widget terminal, a request for device information to the widget terminal according to an internal policy that is managed by the policy managing module; and

a server component library, configured to, after receiving a device information list that is reported by the widget terminal after the widget terminal collects device information according to the request for device information, deliver a component for downloading to the widget terminal, where the component for downloading is stored in the server component library.

Furthermore, in the embodiments of the present invention, by managing a widget component, a size of a widget parsing unit in a terminal and a size of a widget application can be reduced at the time of release; and furthermore, a widget logic component may be updated separately, and a function of a widget terminal is implemented flexibly and easily.

### BRIEF DESCRIPTION OF THE DRAWINGS

To make the technical solutions in the embodiments of the present invention or in the prior art clearer, the accompanying drawings required to be used in the description of the embodiments or the prior art are briefly introduced in the following. Apparently, the accompanying drawings in the following description are only some embodiments of the present invention, and persons of ordinary skill in the art may also obtain other drawings according to these accompanying drawings without creative efforts.

FIG. 1 is a schematic structural diagram of a widget client in the prior art;

FIG. 2 is a flowchart of a method for invoking a widget according to an embodiment of the present invention;

FIG. 3 is a schematic structural diagram of a terminal for invoking a widget according to an embodiment of the present invention;

FIG. 4 is a schematic structural diagram of a system for invoking a widget according to an embodiment of the present invention;

FIG. 5 is a schematic diagram of signaling exchange between a widget terminal and a widget server according to an embodiment of the present invention;

FIG. 6 is a schematic diagram showing an internal structure of a widget terminal according to another embodiment of the present invention;

FIG. 7 is a schematic structural diagram of a component managing unit of a terminal according to an embodiment of the present invention;

FIG. 8 is a schematic structural diagram of a widget component server according to an embodiment of the present invention; and

FIG. 9 is a flowchart of a method for invoking a widget on a widget component server according to an embodiment of the present invention.

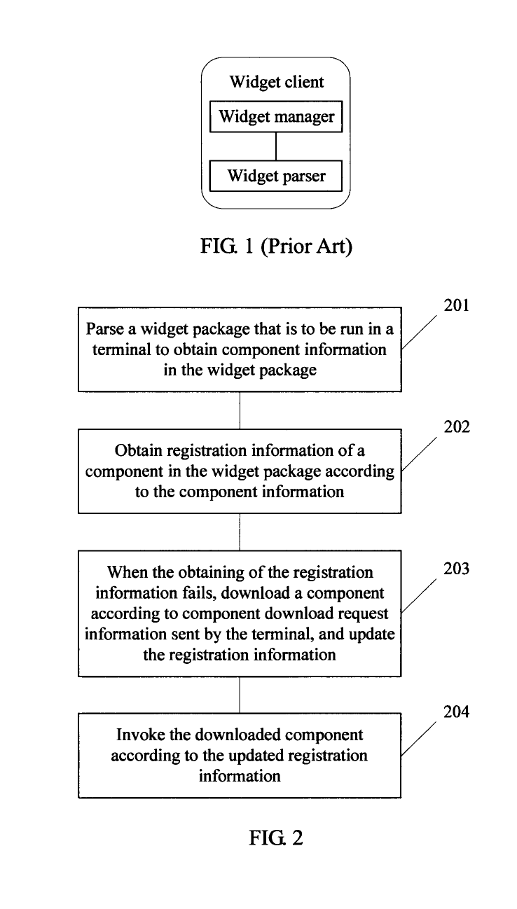

### DETAILED DESCRIPTION OF THE EMBODIMENTS

The technical solutions in the embodiments of the present invention are described in the following with reference to the accompanying drawings in the embodiments of the present invention. The embodiments to be described are only a part rather than all of the embodiments of the present invention. Based on the embodiments of the present invention, all other embodiments obtained by persons of ordinary skill in the art without creative efforts fall within the protection scope of the present invention.

Referring to FIG. 2, an embodiment of the present invention discloses a method for invoking a widget, which includes the following steps:

Step 201: Parse a widget package that is to be run in a terminal to obtain component information in the widget package. It may be understood that the component information here may be preset by a developer and a designer in the widget package. Alternatively, the component information is obtained by the terminal by parsing based on a type or content of the widget package and according to a preset rule.

Step 202: Obtain registration information of a component in the widget package according to the component information.

Step 203: When the obtaining of the registration information fails, download a component according to component download request information sent by the terminal, and update the registration information.

Step 204: Invoke the downloaded component according to the updated registration information.

Optionally, the invoking of the downloaded component according to the updated registration information includes: invoking an un-downloaded component through the downloaded component according to the updated registration information, or directly invoking an un-downloaded component according to the updated registration information. It may be understood that a component A may be triggered by a component B but may not necessarily be triggered by a widget. A dependency relationship exists between components. For example, a widget engine parses a package of a widget and finds that this widget needs to invoke a component B, but this widget package does not indicate that a component A needs to be invoked. When a component managing unit runs the component B, the component managing unit finds that the component B depends on the component A, so that it needs to check whether the component A has been downloaded, and if the component A has been downloaded, the component B is invoked by running the component A.

In this embodiment, the component may be a widget component which is a plug-and-play module that can complete a single or multiple specific functions in a widget. The component may be invoked by a widget manager, and may also serve as an extended function of a scripting language (such as JavaScript) and be invoked by a widget parsing unit. Functionally, the component may control bottom-layer hardware (such as a camera), may also provide an interface for an operating system or other software (for example, capturing a focal point, opening a browser, or starting a multimedia player), and may also be a specific service (such as a map service or a search service) at an application layer.

In this embodiment, the component is downloaded according to the component download request information and the registration information is updated, so that the terminal may dynamically deploy, according to different context scenarios, a service component that is highly related to a widget service, thus avoiding that the widget parsing unit downloads an unnecessary component, and therefore, a size of the widget parsing unit in the terminal and/or a size of a widget application can be reduced at the time of release; and a widget logic component may be updated separately, and a function of a widget terminal is implemented flexibly and easily, that is, plug-and-play.

Optionally, step 203 further includes: when the obtaining of the registration information succeeds, invoking a component corresponding to the successfully obtained registration information.

Optionally, in step 202, the obtaining of the registration information of the component in the widget package according to the component information further includes: obtaining, by the terminal, according to the component information, the registration information of the component from a list that is obtained by an API extension interface, where the list that is obtained by the extension interface is set in the terminal. In this way, an extension API (Application Programming Interface, application programming interface) may also be implemented by means of a component, so as to enhance functions of the widget parsing unit, such as bottom-layer capability invoking and remote control.

The registration information is used for identifying a component, and includes one or multiple kinds of the following: a component name, a component version, a component author, a description of a component function, a description of a dependency relationship between components, and a description of a component execution environment.

Optionally, in step 203, the component download request information may include one or multiple kinds of the following information: terminal hardware configuration information, terminal software configuration information, information about a downloaded component of a terminal, terminal state information, information about a user, and authentication information of the user.

In step 203, the downloading of the component according to the component download request information further includes: reporting, according to the component download request information, a policy to a component server that is corresponding to the terminal, and collecting a component that is returned by the component server to the terminal according to the reported policy. It may be understood that when the component download request information includes hardware configuration information and software configuration information, the terminal may obtain a corresponding component that is sent by the component server according to different kinds of component download request information. Furthermore, with a component downloading manner that is based on the policy, terminal-independent downloading of a widget may be implemented, and a capability difference of bottom-layer software and hardware devices may be shielded for the widget application and the widget parsing unit.

The registration information is used for identifying a specific component, and includes but is not limited to: a component name, a component version, a component author, a description of a component function, a description of a dependency relationship between components, and a description of a component execution environment. A set policy is used for judging how to select a specific component, and includes but is not limited to the following kinds of information: terminal hardware configuration information, terminal software configuration information, a downloaded component of a terminal, terminal state information, information about a user, and authentication information of the user.

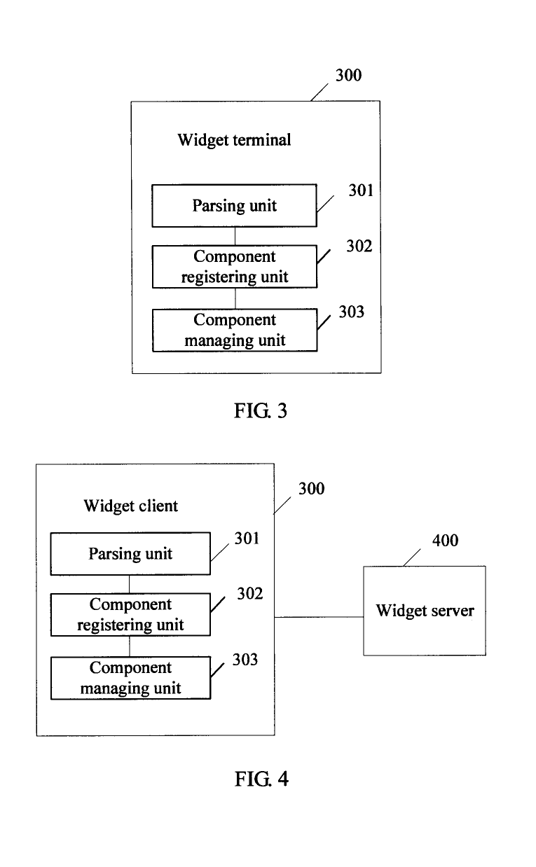

Referring to FIG. 3, an embodiment of the present invention discloses a terminal 300 for invoking a widget, including:

a parsing unit 301, configured to parse a widget package that is to be run in a terminal to obtain component information in the widget package;

a component registering unit 302, configured to obtain registration information of a component in the widget package according to the component information of the parsing unit 301; and

a component managing unit 303, configured to download, when the component registering unit 302 fails to obtain the registration information, a component according to component download request information and update the registration information; and invoke the downloaded component according to the updated registration information.

Optionally, the invoking of the downloaded component by the component managing unit 303 according to the updated registration information includes: invoking an un-downloaded component through the downloaded component according to the updated registration information, or directly invoking an un-downloaded component according to the updated registration information. It may be understood that a component A may be triggered by a component B but may not necessarily be triggered by a widget. A dependency relationship exists between components. For example, a widget engine parses a package of a widget and finds that this widget needs to invoke a component B, but this widget package does not indicate that a component A needs to be invoked. When the component managing unit 303 runs the component B, the component managing unit 303 finds that the component B depends on the component A, so that it needs to check whether the component A has been downloaded, and if the component A has been downloaded, the component B is invoked by running the component A.

With the terminal 300 in this embodiment of the present invention, the parsing unit 301 obtains the component information in the widget package by parsing, and the component registering unit 302 and the component managing unit 303 implement the invoking of the downloaded component, so that the terminal 300 may dynamically deploy, according to different context scenarios, a service component that is highly related to a widget service, and therefore, a size of a widget parsing unit in the terminal and a size of a widget application can be reduced at the time of release, and a logic component may be updated separately, that is, plug-and-play.

Optionally, the component managing unit 303 is further configured to invoke, when the obtaining of the registration information succeeds, a component that is corresponding to the successfully obtained registration information.

Optionally, the component registering unit 302 is further configured to obtain, according to the component information, the registration information of the component from a list that is obtained by an API extension interface (and may also be another extension interface), where the list that is obtained by the API extension interface is set in the component registering unit, and the registration information is used for identifying a component and includes one or multiple kinds of the following: a component name, a component version, a component author, a description of a component function, a description of a dependency relationship between components, and a description of a component execution environment. In this way, an extension API (Application Programming Interface, application programming interface) may also be implemented by means of a component, so as to enhance functions of the widget parsing unit, such as bottom-layer capability invoking and remote control.

Optionally, the component download request information includes one or multiple kinds of the following information: terminal hardware configuration information, terminal software configuration information, information about a downloaded component of a terminal, terminal state information, information about a user, and authentication information of the user.

Optionally, the component managing unit 303 is further configured to report, according to the component download request information, policy information to a component server that is corresponding to the terminal 300, and collect a component that is returned by the component server to the terminal according to the policy information. Furthermore, with a component downloading manner that is based on a policy, terminal-independent downloading of a widget may be implemented, and a capability difference of bottom-layer software and hardware devices may be shielded for the widget application and the widget parsing unit.

Definitely, the component managing unit 303 also collects from a component library 304 of downloaded components in the terminal, according to the component download request information, a component that is returned to the component managing unit 303 according to the component download request information.

Referring to FIG. 4, this embodiment discloses a system for invoking a widget, including a widget terminal 300 and a widget server 400. The widget terminal 300 is configured to parse a widget package that is to be run in the widget terminal to obtain component information in the widget package; obtain registration information of a component in the widget package according to the component information; and when the obtaining of the registration information fails, send component download request information. The widget server 400 is configured to deliver a component according to the component download request information of the widget terminal 300. After downloading the component from the widget server 400 and updating the registration information, the widget terminal 300 invokes the downloaded component according to the updated registration information.

Optionally, the invoking of the downloaded component by the widget terminal 300 according to the updated registration information includes: invoking an un-downloaded component through the downloaded component according to the updated registration information, or directly invoking an un-downloaded component according to the updated registration information. It may be understood that a component A may be triggered by a component B but may not necessarily be triggered by a widget. A dependency relationship exists between components. For example, a widget engine parses a package of a widget and finds that this widget needs to invoke a component B, but this widget package does not indicate that a component A needs to be invoked. When a component managing unit runs the component B, the component managing unit finds that the component B depends on the component A, so that it needs to check whether the component A has been downloaded, and if the component A has been downloaded, the component B is invoked by running the component A.

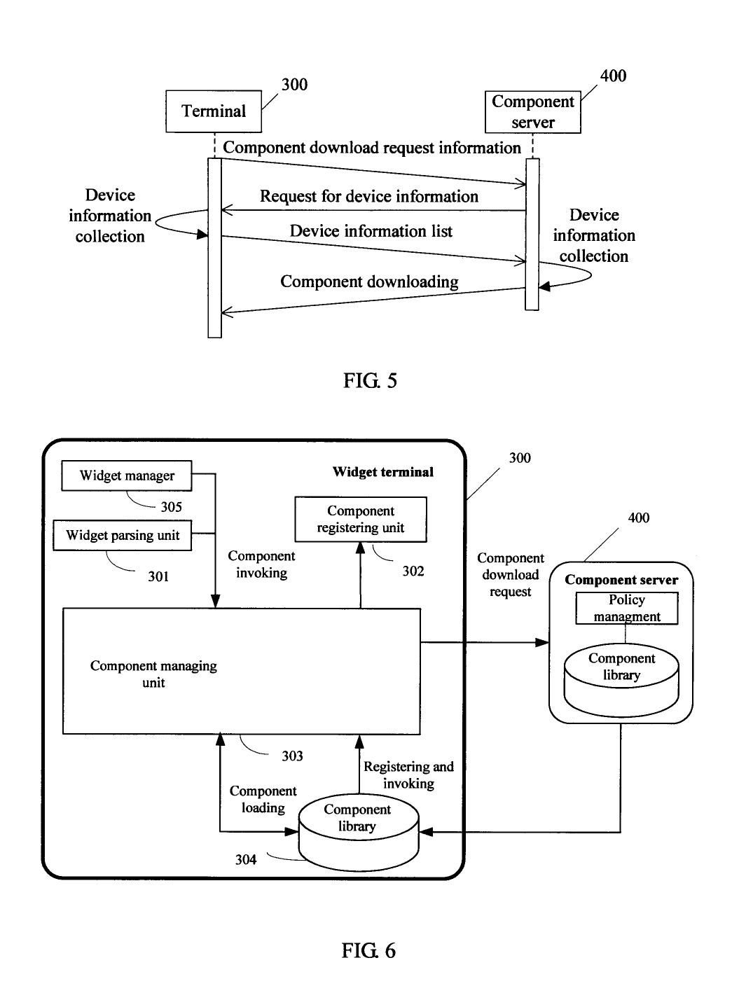

Optionally, referring to FIG. 5 together, FIG. 5 shows a manner of signaling exchange between a widget terminal and a widget server. After receiving the component download request information reported by the terminal 300, the widget server 400 delivers a request for device information to the terminal 300, and after receiving a device information list that is reported by the terminal 300 after the terminal 300 collects device information according to the request for device information, the widget server 400 delivers a component for downloading to the terminal 300.

Optionally, the widget server 400 is configured to deliver a component for downloading to the widget terminal according to an internal policy of the widget server 400 after receiving the component download request information reported by the terminal 300. The internal policy of the widget server 400 includes one or multiple kinds of the following information: terminal hardware configuration information, terminal software configuration information, information about a downloaded component of a terminal, terminal state information, information about a user, and authentication information of the user.

Specifically, as shown in FIG. 6, a widget terminal 300 in this embodiment includes: a widget parsing unit (also called a widget engine) 301, a component registering unit 302, a component managing unit 303, a component library 304, and a widget manager 305.

The widget manager 305 is configured to perform user and widget management, for example, managing user configuration information, recording a using log, downloading, updating, and deleting a widget, and other enhanced functions (such as traffic statistics, security authentication, and advertisement support).

The widget parsing unit 301 is configured to parse and run a widget package, and the widget package includes a widget unpacking unit, a markup language (HTML or XML) engine, a scripting language (JavaScript) engine, and a CSS engine. Component information in the widget package is obtained.

The component registering unit 302 is configured to obtain registration information of a component in the widget package according to the component information of the widget parsing unit 301, that is, a component is registered after being downloaded into the component library 304, so that the widget manager 305 and the widget parsing unit 301 check whether the component is available before invoking the component.

The component managing unit 303 manages a life cycle of a component, such as downloading, updating, and deletion, and provides a running environment for the component, so that a difference between bottom-layer software and bottom-layer hardware is shielded for the widget, the widget manager, and the widget parsing unit.

The component library 304 is configured to provide a storage space for a downloaded component for invoking by the component managing unit.

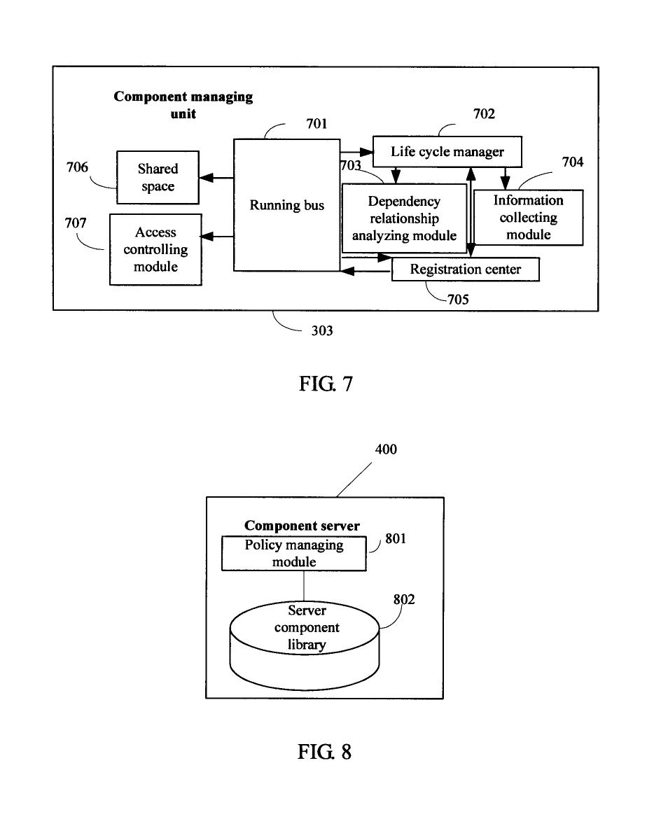

Referring to FIG. 7, in this embodiment, a component managing unit 303 of a terminal further includes: a running bus 701, a life cycle manager 702, a dependency relationship analyzing module 703, an information collecting module 704, a registration center 705, a shared space 706, and an access controlling module 707.

The running bus 701 is configured to process a request for invoking a component and provide a running environment for the component.

The life cycle manager 702 manages dynamic downloading, updating, installation, and deletion of the component.

The dependency relationship analyzing module 703 is configured to analyze a dependency relationship between components. There may be a dependency relationship of mutual invoking between components, and this dependency relationship may be expressed by means of a component configuration file (XML).

The information collecting unit 704 collects software and hardware information of a terminal system, so that different component versions are selected when a component is downloaded.

The registration center 705 is different from “a component registering unit” that is used by a widget manager and a widget parsing unit. The registration center 705 here is used by the running bus and the life cycle manager for querying whether a certain component has been downloaded, and querying for other relevant information of this component, such as a dependency relationship, a version, a storage path, and a size.

The access controlling module 707 controls, according to a signature file delivered with a component, and/or a security policy file of a device itself, a scope of a component accessing bottom-layer hardware and system software.

The shared space 706 provides a storage space shared among components, and is used for information exchange, information synchronization, and remote control among components.

With reference to FIG. 6 together, in this embodiment, a widget manager 305 and a widget parsing unit 301 may invoke a required component through the running bus 701 in the component managing unit 303. Before running a component, the running bus 701 firstly checks whether the component and another component on which the component depends have been downloaded into a component library 304. If the components have not been downloaded, the life cycle manager 702 in the component managing unit 303 requests a component server 400 to download the components; and if required components have been downloaded, the components run after being loaded from the component library 304. During the running, the components may read and write data in the shared space 706 in the component managing unit 303, and communication between the components is implemented through the shared space 706. If bottom-layer software and hardware resources need to be accessed during the running, authentication may need to be performed through the access controlling module 707 in the component managing unit before access, and the access may be performed only when a security policy permits.

In this embodiment, a service component that is highly related to a widget service is dynamically deployed according to different context scenarios of a terminal, so that a size of the widget parsing unit, a size of the widget manager, and a size of a widget application can be reduced at the time of release; an extension API interface is implemented by means of a component, so as to enhance functions of the widget parsing unit, such as bottom-layer capability invoking and remote control; presentation and logic are separated, and a logic component may be updated separately, that is plug-and-play; and with a component downloading manner that is based on a policy, terminal-independent downloading of a widget may be implemented, and a capability difference of bottom-layer software and hardware devices is shielded for the widget application and the widget parsing unit.

Referring to FIG. 8, this embodiment provides a widget component server 400, including a policy managing module 801 and a server component library 802. The component server 400 stores various components with multiple versions and may be a separate component server, and may also be provided by an equipment manufacturer, a widget server provider, or a specific service provider (SP). The component server 400 is generally connected through a network.

The policy managing module 801 is configured to, after receiving component download request information reported by a widget terminal 300, deliver a request for device information to the widget terminal according to an internal policy that is managed by the policy managing module 801; and the server component library 802 is configured to deliver a component for downloading to the widget terminal 300 after receiving a device information list that is reported by the widget terminal 300 after the widget terminal 300 collects device information according to the request for device information, where the component for downloading is stored in the server component library 802.

Optionally, the widget server 400 is configured to deliver a component for downloading to the widget terminal according to an internal policy of the widget server 400 after receiving the component download request information reported by the terminal 300.

Because the same component may be implemented in different ways according to different running environments, these components with different versions may be stored on a remote component server 400. A remote widget server 400 decides, according to different software and hardware environments of the widget terminal 300, which version of a component is to be returned. The policy managing module 801 is responsible for managing a mapping relationship between different versions of different components and download policies. A component that is requested to be downloaded is delivered based on a management policy of the policy managing module 801.

A download policy of the policy managing module 801 may include one or multiple kinds of the following:

terminal hardware configuration information, for example, a device model, a memory size, and whether a camera exists; terminal software configuration information, for example, an operating system version and a browser version; terminal state information, for example, a network condition and battery power; user information, for example, a record of a user action; and a downloaded component of a terminal and a dependency relationship between components.

An example that when the terminal 300 requests a component from the component server 400, the component server 400 selects to deliver different versions of the component according to different policies is as follows:

Optionally, a decision is made according to hardware configuration information reported by the terminal 300. Taking a contact location component as an example, the component can return a current geographical location of a user to a widget through a programming interface. When this component is requested, the component server needs to know whether the terminal supports GPS. If the terminal supports GPS, a component for invoking GPS is returned, and if the terminal does not support GPS, an approximate location of the user is returned, where the approximate location of the user is guessed through a cell identity of a mobile phone. In addition, many components relating to graphic image processing are sensitive to a screen size of the terminal. Therefore, a screen size or terminal model needs to be obtained in advance, where the screen size or terminal model is reported by the terminal, and then, terminal screen size information that is corresponding to the terminal of this model is found in a database that is stored in the server component library 802 on the server 400.

Optionally, a decision is made according to terminal software information: Some components need to invoke an interface provided by an operating system, such as a graphical interface. An intuitive, understandable and easy-to-use user operating environment is formed on a desktop through an icon, a window, a menu, a dialog box, and another element. Furthermore, there are many kinds of operating systems for a widget terminal. In this case, the terminal needs to report operating system information. Some components need to depend on a terminal program to complete an auxiliary function, for example, invoking a terminal browser, a multimedia player, and a multimedia decoder. In this case, the terminal needs to report local specific software information, and finds a corresponding component according to the software information, or downloads uninstalled software at the same time, or refuses downloading.

Optionally, a decision is made according to terminal state information: When a component requested by the terminal is larger, and longer download time or a larger network bandwidth is needed, the component server may require the terminal to report a network state and remaining power of the terminal, and different selections are made according to different network states and remaining power to avoid unnecessary resource consumption.

Optionally, a decision is made according to user information: Some components are not accessible to all users. When requesting a component, the terminal needs to report user identification information, such as a user name and a password, and after authentication of the component server, whether to return the requested component is decided.

Optionally, a decision is made according to a dependency relationship between components of the terminal: In addition to being invoked by a widget application or a widget manager through a programming interface, a component may also be invoked by another component to complete a specific function in collaboration. For example, a contact map component displays a set contact on a map. This component needs to depend on a PIM (Personal information management) component, a map component, and a contact location component for cooperative work. Therefore, the contact map component forms a dependency relationship with these three components. When the contact map component is requested, it is necessary to know whether the terminal has downloaded depended components and versions of the depended components. A decision is made according to the dependency relationship, for example, only the contact map component needs to be downloaded, the contact map component and all or part of depended components need to be downloaded, or the contact map component needs to be downloaded after a certain depended component is upgraded.

Furthermore, with a component downloading manner that is based on a policy, terminal-independent downloading of a widget may be implemented, and a capability difference of bottom-layer software and hardware devices may be shielded for the widget application and the widget parsing unit.

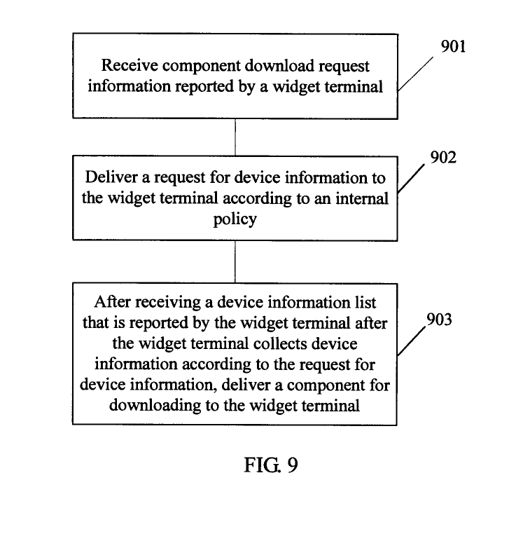

As shown in FIG. 9, an embodiment of the present invention provides a method for invoking a widget on a widget server, including the following steps:

Step 901: Receive component download request information reported by a widget terminal.

Step 902: Deliver a request for device information to the widget terminal according to an internal policy.

Step 903: After receiving a device information list that is reported by the widget terminal after the widget terminal collects device information according to the request for device information, deliver a component for downloading to the widget terminal.

Optionally, the internal policy includes one or multiple kinds of the following: terminal hardware configuration information, terminal software configuration information, terminal state information, user information, information about a downloaded component of a terminal, and a dependency relationship between components.

The widget server selects to deliver different versions of the component according to different internal policies.

With the method, apparatus, and system for invoking a widget that are provided in the embodiments of the present invention, component information in a widget package is obtained; registration information of a component in the widget package is obtained according to the component information; when the obtaining of the registration information fails, a component is downloaded according to component download request information sent by a terminal and the registration information is updated; the downloaded component is invoked according to the updated registration information, so that a size of a widget parsing unit, a size of a widget manager, and a size of a widget application in the terminal are reduced at the time of release; and a logic component may be updated separately, that is, plug-and-play.

Persons of ordinary skill in the art may understand that all or part of processes in the methods of the preceding embodiments may be implemented by relevant hardware instructed by a computer program. The program may be stored in a computer readable storage medium, and when the program is executed, the processes in the methods of the preceding embodiments may be executed. The storage medium may be a magnetic disk, an optical disk, a read-only memory (Read-Only Memory, ROM), or a random access memory (Random Access Memory, RAM).

The preceding descriptions are only specific embodiments of the present invention, but are not intended to limit the protection scope of the present invention. Any modification or replacement that is easily thought by persons skilled in the art within the technical scope disclosed in the present invention shall be covered within the protection scope of the present invention.

What is claimed is:

1. A method for invoking a widget, comprising:
parsing a widget package that is to be run in a terminal to obtain component information in the widget package;
obtaining registration information of a component in the widget package according to the component information;
when the obtaining of the registration information fails, downloading a component according to component download request information from the terminal, and updating the registration information; and
invoking the downloaded component according to the updated registration information.

2. The method according to claim 1, wherein when the obtaining of the registration information succeeds, a component that corresponds to the successfully obtained registration information is invoked.

3. The method according to claim 1, wherein the obtaining the registration information of the component in the widget package according to the component information further comprises:
obtaining, by the terminal, according to the component information, the registration information of the component from a list that is obtained by an extension interface, wherein the list that is obtained by the extension interface is set in the terminal.

4. The method according to claim 1, wherein:
the registration information is used for identifying a component, and comprises one or multiple kinds of the following: a component name, a component version, a component author, a description of a component function, a description of a dependency relationship between components, or a description of a component execution environment; and
the component download request information further comprises one or multiple kinds of the following information: terminal hardware configuration information, terminal software configuration information, information about a downloaded component of the terminal, terminal state information, information about a user, or authentication information of the user.

5. The method according to claim 1, wherein the downloading the component according to the component download request information further comprises:
reporting, according to the component download request information, a policy to a component server that corresponds to the terminal, and collecting a component that is returned by the component server to the terminal according to the reported policy.

6. The method according to claim 1, wherein the invoking the downloaded component according to the updated registration information further comprises: invoking an un-downloaded component through the downloaded component according to the updated registration information.

7. A terminal for invoking a widget, comprising:
a parsing unit, configured to parse a widget package that is to be run in a terminal to obtain component information in the widget package;
a component registering unit, configured to obtain registration information of a component in the widget package according to the component information; and
a component managing unit, configured to download, when the obtaining of the registration information fails, a component according to component download request information and update the registration information; and invoke the downloaded component according to the updated registration information.

8. The terminal according to claim 7, wherein the component managing unit is further configured to invoke, when the obtaining of the registration information succeeds, a component that is corresponding to the successfully obtained registration information.

9. The terminal according to claim 7, wherein the component registering unit is further configured to:
obtain, according to the component information, the registration information of the component from a list that is obtained by an extension interface, wherein the list that is obtained by the extension interface is set in the component registering unit, and the registration information is used for identifying a component and comprises one or multiple kinds of the following: a component name, a component version, a component author, a description of a component function, a description of a dependency relationship between components, or a description of a component execution environment.

10. The terminal according to claim 7, wherein the component download request information comprises: terminal hardware configuration information, terminal software configuration information, information about a downloaded component of the terminal, terminal state information, information about a user, or authentication information of the user.

11. The terminal according to claim 7, wherein the component managing unit is further configured to report, according to the component download request information, policy information to a component server that is corresponding to the terminal, and collect a component that is returned by the component server to the component managing unit according to the policy information.

12. A method for invoking a widget, comprising the following steps:
receiving component download request information reported by a widget terminal;
delivering a request for device information to the widget terminal according to an internal policy; and
after receiving a device information list that is reported by the widget terminal after the widget terminal collects device information according to the request for device information, delivering a component for downloading to the widget terminal.

13. The method according to claim 12, wherein the internal policy comprises one or multiple kinds of the following:
terminal hardware configuration information, terminal software configuration information, terminal state information, user information, information about a downloaded component of the terminal, or a dependency relationship between components; and
according to different internal policies, different versions of the component are selected for delivery.

14. An apparatus for invoking a widget, comprising a policy managing module and a server component library, wherein:
the policy managing module is configured to deliver, after receiving component download request information reported by a widget terminal, a request for device information to the widget terminal according to an internal policy that is managed by the policy managing module; and
a server component library, configured to deliver a component for downloading to the widget terminal after receiving a device information list that is reported by the widget terminal after the widget terminal collects device information according to the request for device information, wherein the component for downloading is stored in the server component library.

15. The apparatus according to claim 14, wherein the internal policy comprises one or multiple kinds of the following:
terminal hardware configuration information, terminal software configuration information, terminal state information, user information, information about a downloaded component of the terminal, or a dependency relationship between components; and
according to different internal policies, different versions of the component are selected through the server component library for delivery.
